(19) United States
(12) Patent Application Publication
(10) Pub. No.: US 2010/0000070 A1
(43) Pub. Date: Jan. 7, 2010

(54) Reusable core carbon-carbon composite brake disc

(76) Inventors: Mark L. La Forest, Granger, IN (US); Slawomir T. Fryska, Granger, IN (US); Christopher S. Wahlers, South Bend, IN (US); Darrell L. Johnson, South Bend, IN (US); Allen H. Simpson, Buchanan, MI (US)

Correspondence Address: HONEYWELL/BSKB;PATENT SERVICES, 101 COLUMBIA ROAD, P.O. BOX 2245, MORRISTOWN, NJ, 07962-2245, US

(21) Appl. No.: 11/028,719

(22) Filed: Jan. 4, 2005

Related U.S. Application Data
(60) Provisional application No. 60/558,112, filed on Apr. 1, 2004.

(51) Int. Cl. B21J 15/00; B32B 37/02

(52) U.S. Cl. 29/525.06; 156/60; 264/259; 427/255.28

(57) ABSTRACT

Method of manufacturing carbon-carbon composite brake disc comprising a dense reusable core. Preferably, the reusable core has a density of 1.8-2.05 g/cc. The method includes: forming a dense carbon-carbon composite core; positioning the dense core in a location within a carbon-carbon composite brake disc; and fixing the dense carbon-carbon composite core in place in its location within the carbon-carbon composite brake disc. It is economically advantageous to recover the dense core from a worn brake disc prior to positioning it in the brake disc. Also, an annular carbon-carbon composite brake disc made up of a friction surface containing 15-75 weight-% carbon-containing fibers and 25-85 weight-% resin binder and a dense carbon-carbon composite core comprising 40-75 weight-% carbon-containing fibers and 25-60 weight-% resin binder.

### CROSS-REFERENCE TO RELATED APPLICATION

This application claims priority under 35 U.S.C. §119(e) to provisional application Ser. No. 60/558,112, which was filed on Apr. 1, 2004. The disclosure of Ser. No. 60/558,112 is incorporated herein by reference.

### FIELD OF THE INVENTION

This application relates to carbon-carbon composite brake discs and to methods of manufacturing them. Preferred embodiments of the present invention contemplate carbon-carbon composite brake discs employed in aircraft landing systems.

### BACKGROUND OF THE INVENTION

Carbon-carbon composite friction materials are used in aircraft brakes due to their high heat capacity, their ability to function as a friction material and their resistance to oxidation at elevated temperatures. Carbon-carbon composite brakes have various components including rotors, stators, backing plates, and pressure plates, all of which may be made of carbon-carbon composite friction materials.

Two major cost areas associated with aircraft brakes are the initial cost, which includes raw material costs and the cost (for energy, etc.) of manufacturing process steps, and maintenance costs, including the need to replace the friction material due to wear. Carbon-carbon composites can be manufactured only slowly—it can take up to four months to complete the manufacturing process. Accordingly, the cost of the material is necessarily high. Also, carbon-carbon composites generally are subject to significant wear during taxiing. Nevertheless, many aircraft brakes are made of carbon-carbon composite materials because such materials provide high heat capacity while having relatively low mass.

Aircraft brakes are subjected to high temperatures in use. The temperature at which a carbon-carbon composite brake can operate is limited by the ability of surrounding structures (e.g., hydraulic piston assembly, wheel, and tire) to withstand the temperature generated by the carbon-carbon heat sink and also by the tendency of carbon-carbon composites to oxidize at higher temperatures, weakening the carbon-carbon composite structures. This may lead to failure of the brakes to provide sufficient torque to stop the aircraft. Also, the amount of energy that must be absorbed to stop the aircraft during landing increases with the increase in size and speed of the aircraft.

Over the years, much effort has gone into the search for improved approaches to the design and manufacture of carbon-carbon composite brake discs. The following patents are illustrative of developments in the field.

U.S. Pat. No. 3,724,612 discloses a brake disc comprising an annular housing (20) having an annular insert (21), said insert having a frictional surface (34). The insert can be replace when the frictional surface becomes worn.

U.S. Pat. No. 3,724,613 discloses a brake disc comprising a beryllium core plate (12) having a plurality of drive slots (16) uniformly located on its out periphery.

U.S. Pat. No. 3,871,934 and its division, U.S. Pat. No. 4,002,225, describe a method for providing friction surfaces on brake discs which comprises the use of tapes impregnated with curable resins, which tapes may also include boron-containing or other additives.

U.S. Pat. No. 3,956,548 claims a carbon composite brake disc comprising a reusable carbon composite core, of carbon cloth fiber and pyrolized high coking value material, a carbon composite low wear layer, and a carbon felt layer bonded to the core and to the low wear layer by a pyrolized high carbon bearing cement layer. The core preferably has a density of from 1.7 to 2.0 gms/cc. The core is taught to have a thickness of from about 0.350 to about 0.385 inches and the wear plate is taught to have a thickness of from about 0.100 to about 0.150 inches.

U.S. Pat. No. 4,026,393 shows a plurality of annular blocks (18) of resistant material seated in annular grooves (11, 12) in a brake disc.

U.S. Pat. No. 4,613,021 shows a spoked core (1) upon which are mounted removable friction pad sectors (8).

Claim 1 of U.S. Pat. No. 4,982,818 reads: A method of manufacturing a carbon-carbon composite friction disc from worn parts comprising: radially splitting a worn carbon disc into equal disc halves; machining each disc half to a predetermined thickness dimension; and bonding the disc halves to each side of a carbon-carbon composite core member.

In U.S. Pat. No. 5,439,077, FIG. 1 shows two ring bodies (14, 14) joining together two friction ring halves (4, 5).

The marketplace demands friction materials with very high heat capacity (e.g., A380, JSF). Economic considerations necessitate, among other things, minimization of raw materials costs. It is known in the industry, of carbon brake manufacturing for aircraft landing systems, that higher density may lead to significant improvement in heat capacity and/or to systems weight savings. Also, higher density improves overall friction performance. The present invention provides high heat capacity brake discs, made in an economically advantageous manner. The present invention differs from previous technology in the carbon brake manufacturing industry that has cores or inserts. These cores or inserts have lugs for the purpose of transferring torque. The present invention does not have lugs and is not intended for torque transfer. The present invention provides increased heat capacity of the heat stack and reduces heat stack manufacturing and usage costs.

### SUMMARY OF THE INVENTION

The present invention provides an improved method of manufacturing a carbon-carbon composite brake disc comprising a dense reusable core. Preferably, the reusable core has a density of from 1.8 g/cc to 2.05 g/cc. The method of this invention includes the steps of: forming a dense carbon-carbon composite core; positioning the dense core in a location within a carbon-carbon composite brake disc; and fixing (e.g., by molding, riveting, or adhering) the dense carbon-carbon composite core in place in its location within the carbon-carbon composite brake disc. More particularly, this manufacturing method may include the steps of: forming a dense carbon-carbon composite core with high heat capacity; positioning the dense core in a mold; and forming a carbon-carbon composite brake disc preform around the core in said mold. Alternatively, this manufacturing method may include the steps of: forming a carbon-carbon composite brake disc preform having a cavity located therein; forming a dense carbon-carbon composite core with high heat capacity; positioning the dense core into the cavity in the carbon-carbon composite brake disc preform; and fixing the core in the cavity in said carbon-carbon composite brake disc preform. It is economically advantageous if the dense core is recovered from a worn brake disc prior to positioning it in the brake disc.

Thus, another aspect of this invention is a method of lowering the cost of manufacturing carbon-carbon composite brake discs over a series of manufacturing runs. In this method, the basic steps are: (a) forming a dense carbon-carbon composite core with high heat capacity; (b) positioning the dense core in a location within a carbon-carbon composite brake disc; (c) fixing the dense carbon-carbon composite core in place in its location within the carbon-carbon composite brake disc; (d) recovering the dense carbon-carbon composite core from a worn brake disc; and (e) repeating steps (b) and (c) with a core recovered in step (d). Generally, in this aspect of the invention, the step of repeating step (e) is itself repeated one or more times.

Another aspect of the present invention is embodied by a molded carbon-carbon composite brake disc having a reusable core of dense material (and preferably, having a high heat capacity) fixed therein, for instance by being molded or riveted or adhered therein.

Alternatively, the molded carbon-carbon composite brake disc may be constructed such that the reusable core is held in place within the brake disc solely by annular carbon-carbon composite disc portions that are riveted to one another. In this embodiment of the invention, a small positioning pin or dimple may be employed to prevent the rotation of the heavy core with respect to the carbon-carbon composite disc halves. The terminology “high heat capacity” in this context means heat capacity higher than the heat capacity of the non-dense core portions of the of the carbon-carbon composite brake disc. This invention contemplates also an annular carbon-carbon composite brake disc comprising a friction surface containing 15-75 weight-% carbon-containing fibers and 25-85 weight-% resin binder and a dense carbon-carbon composite core comprising 40-75 weight-% carbon-containing fibers and 25-60 weight-% resin binder.

### BRIEF DESCRIPTION OF THE DRAWINGS

The present invention will be more fully understood from the detailed description given hereinafter and from the accompanying drawings. The drawings are not to scale, and are presented for illustrative purposes only. Thus the drawings are not intended to limit the present invention.

FIG. 1 presents a top plan view, a cutaway side view, and an exploded cutaway side view of a carbon-carbon composite disc embodiment of the present invention.

FIG. 2 presents a top plan view of a carbon-carbon composite brake disc stator embodiment of this invention.

FIG. 2A presents a cutaway side view of the carbon-carbon composite brake disc stator embodiment of FIG. 2.

FIG. 3 provides a cutaway side view of another carbon-carbon composite brake disc stator in accordance with the present invention.

FIG. 4 is a schematic illustration of a carbon-carbon composite brake disc recycling procedure that can be implemented in connection with the present invention.

FIG. 5 provides an isometric view of a worn carbon-carbon composite disc that is processed in the procedure illustrated in FIG. 4.

FIG. 6 is a top plan view and a cutaway side view of carbon-carbon composite brake disc rotor embodiment of this invention.

### DETAILED DESCRIPTION OF THE INVENTION

The present invention contemplates incorporating a reusable high heat capacity carbon-carbon composite core into a carbon-carbon composite brake disc.

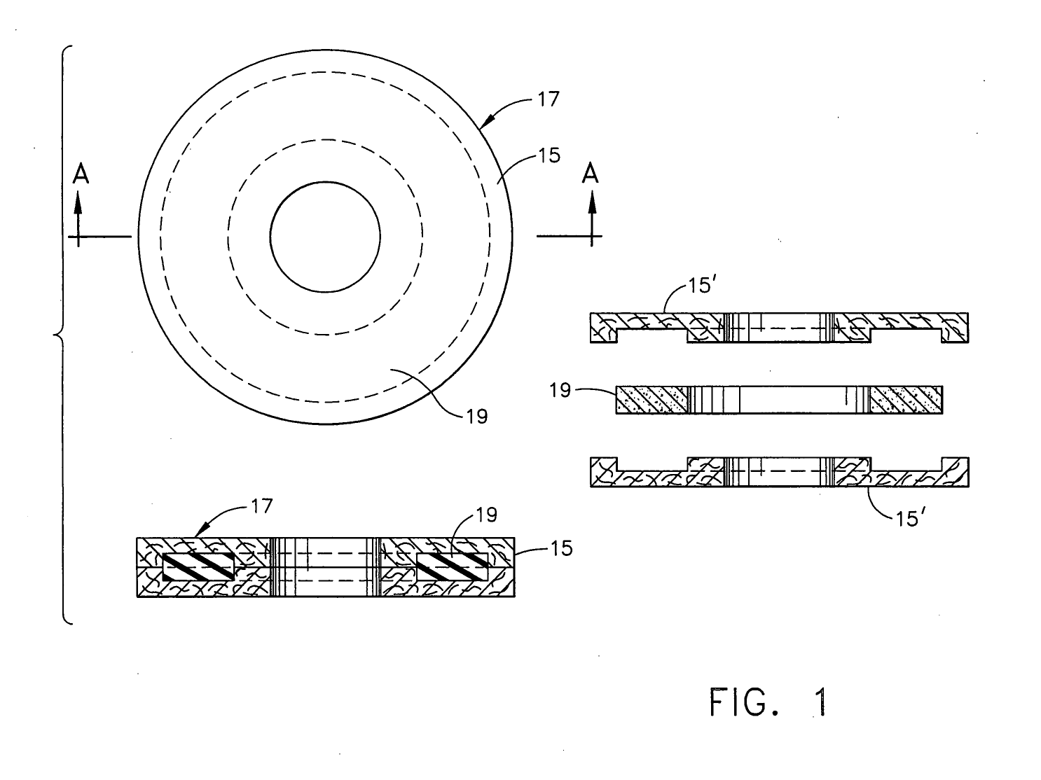

The segmented/reusable core brake: The frictional surface of the 3-piece brake disc can be molded or laid-up to near net shape, having a pocket to accept the high-density core produced from the carbon-carbon process. FIG. 1 illustrates one embodiment of this invention. To the left in FIG. 1, there is a top plan view of a carbon-carbon composite brake disc 17 and a cutaway side view of disc 17 along line A-A of the top plan view. Brake disc 17 is composed of a high heat capacity material core 19 surrounded by a carbon-carbon composite portion 15. To the right in FIG. 1, this cutaway side view is shown exploded so that the annular nature of high heat capacity material core 19 in this embodiment can be more clearly visualized. In practice, however, the carbon-carbon composite portion 15 would be formed as a single unit around core 19 rather than as two separate carbon-carbon composite portions 15′.

Conventional CVD on thick carbon-carbon composite brake discs does not impart high density to the core of such discs. This is because the carbon-containing gas can only reach the core area after going through the outer areas of the disc, and much of the carbon is deposited in the outer areas of the disc before the gas even reaches the core area. Normally, therefore, the core of a conventionally processed brake disc is actually less dense than is the outer edges of the disc. The present invention overcomes that problem.

The 2-piece layer surrounding the core (the frictional surface), because it is thinner, will reach greater density in conventional CVD and even higher density when combined with high carbon-yielding pitch resin infiltration or RTM. Current brake preforms reach densities of ˜1.7 g/cc with conventional CVD and when combined with pitch infiltration the densities reach ˜1.8 g/cc (brake preforms 1 inch or greater in thickness). With the present invention, the two carbon halves housing the core will be less than ½ inchin thickness, which will lead to significantly higher density in conventional CVD (1.75-1.8 g/cc) and significantly higher still (1.85-1.9 g/cc) when combined with pitch infiltration. Consequently, the higher density frictional surface combined with the high-density core will greatly improve heat capacity and overall frictional performance. In accordance with the present invention, the density of the core is preferably in the range 1.8 to 2.05 grams per cubic centimeter (g/cc). These high densities may be obtained, for example, by the use of Resin Transfer Molding (RTM) procedures with high carbon-yielding pitch resins in combination with high temperature heat treatments. Use of this combination of known procedures in the context of the present invention allows for greater porosity and enables those skilled in the art to achieve core densities ranging as high as 2.05 g/cc.

The core is completely reusable. The core and the outer halves are assembled similarly to the manner in which current refurbished products are produced. When the brake is completely worn, it will be overhauled or re-built. Then the high-density core (completely reusable) will be inserted into a new set of outer carbon brake material. Since the core will represent a large portion of the brake disk, a significant saving will be recognized in material and overall manufacturing costs.

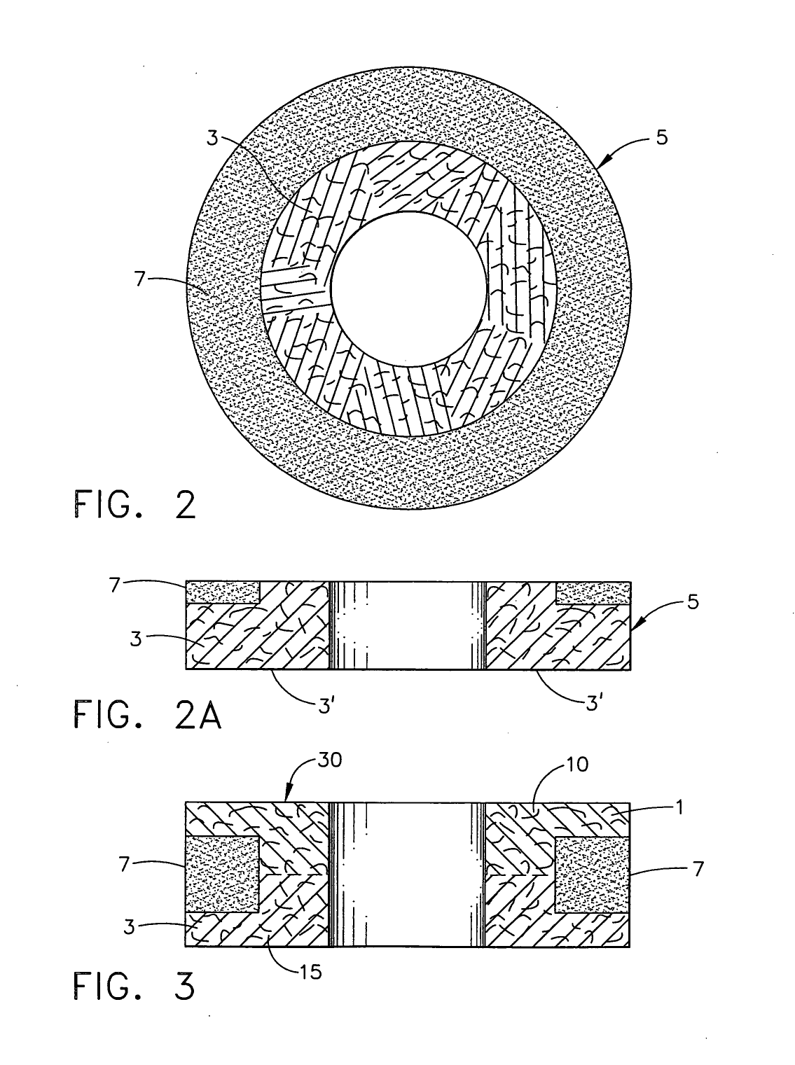

REUSABLE CORE. FIGS. 2 and 3 illustrate alternative embodiments of the present invention.

FIG. 2 illustrates a reusable dense, high heat capacity core embodiment of this invention. FIG. 2 includes a top plan view of a carbon-carbon composite brake disc 5 and FIG. 2A is a cutaway side view of brake disc 5. Brake disc 5 is composed of a conventional carbon-carbon composite portion 3 and a high heat capacity material core 7 in accordance with this invention. The disc illustrated in FIGS. 2 and 2A are an end plate (backing plate or pressure plate) where one disc surface (3′) is the carbon-carbon composite friction surface and the other surface contains the high density reusable core 7.

FIG. 3 illustrates a lower brake disc portion 15 joined to an upper brake disc portion 10, both made in accordance with this invention. Both upper brake disc portion 10 and lower brake disc portion 15 are respectively composed of a conventional carbon-carbon composite portions 1 and 3 and high heat capacity material core 7 of this invention. Bonded or fastened together as shown in FIG. 3, they form a brake disc 30 having a high density reusable core 7 trapped between two carbon-carbon composite elements 1 and 3 in accordance with the present invention.

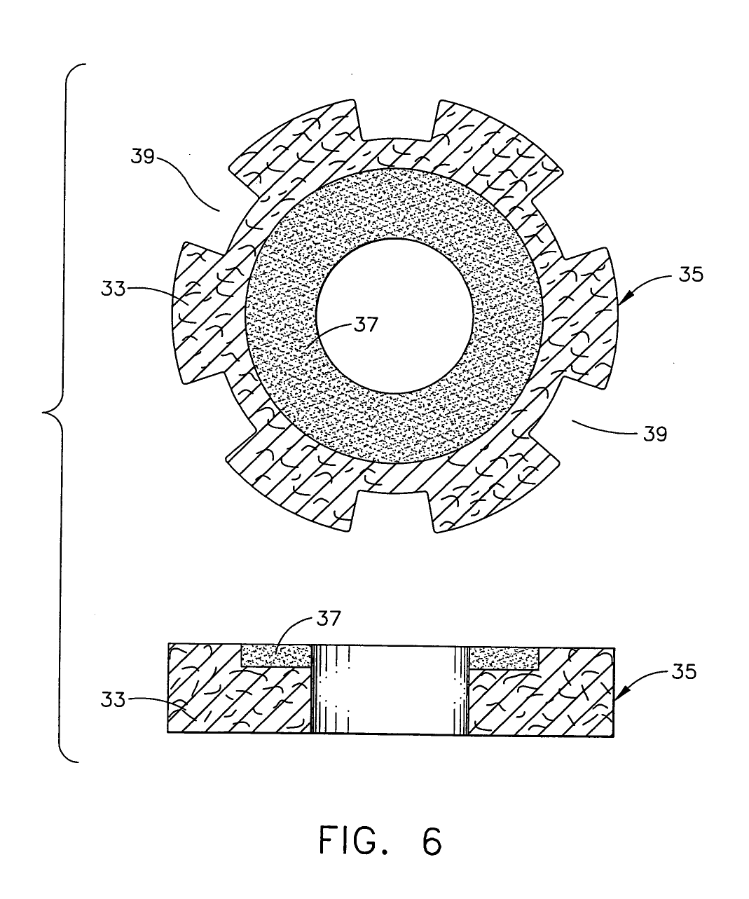

In FIGS. 2, 2A and 3, the heavy core OD is the same as the brake disc OD. In practice, these would be used as brake stators, and torque transferring lugs would be cut at their inside diameters. The lugs are omitted in FIGS. 2 and 3 for the sake of simplicity. FIG. 6 illustrates a brake rotor 35 in which the ID of the heavy core 37 is the same as the ID of the carbon-carbon composite 33, and in which lugs 39 are cut in the outside diameter.

PREFORM FORMATION. In accordance with the present invention, the brake frictional surface and the reusable core can be made by any conventional method. The core can be located at a desired position in the mold, and then the remainder of the carbon-carbon composite—that is, the frictional material, can be formed around the core in the mold. Alternatively, an entire carbon-carbon composite brake disc could be formed in a mold, and then a pocket could be machined out of it, with the reusable core then being “glued” into the pocket or even riveted into the pocket. Those skilled in the art are well aware of methods for fixing carbon-carbon composite pieces into carbon-carbon composite brake discs. For instance, U.S. Pat. No. 3,800,392 discloses the use of metal clips or rivets in this context, and U.S. Pat. No. 4,742,948 discloses the use of brazing compounds or adhesive pitches in this context. The disclosures of U.S. Pat. Nos. 3,800,392 and 4,742,948 are incorporated herein by reference.

In a non-limiting example of one way to make a carbon-carbon composite preform in accordance with this invention, a dense core is situated in a preform mold. Then a desired amount of fiber material and binder is deposited into the mold, and a heavy ring-shaped lid is pressed slowly into the mold to compress the fibrous matrix. The lid is perforated to allow air to escape during the placement of the lid onto the fiber body. The mold containing the still fibrous preform is subsequently moved to a furnace and heated. The heated preform is then moved to a press and consolidated within the ring-shaped mold, forming a consolidated preform for the final composite part from the softened binder resin, the fibers, and the high heat capacity material core. The first portion of the cycle forms the preform part under high pressure (e.g., about 170 tons), with the pressure being dependent upon the area of the part. This first portion of the cycle also includes a breathing cycle to eliminate volatile chemical compounds that could cause defects. After finishing the press cycle and subsequent cooling, the consolidated preform is removed from the mold. In a second compaction stage the preform is placed into a mold to form the final product under high pressure and temperatures (normally exothermic temperatures). Over the remaining portion of the cycle, the resin undergoes cure. However, the resin never reaches total cure in the press. The preform is then placed in an oven to go through a slow ramp cycle (up to about 250° C.). Once this temperature is reached and held, the resin is completely cured and then the preform moves to the carbonization furnace to convert to carbon.

DENSIFICATION. Resin Transfer Molding, for instance of liquid synthesized mesophase pitches with high carbon yield (higher than 80%), can be used to densify the preform. The part to be injected is preheated and placed into a form-fitting cavity in a mold attached to the extruder and accumulator. The mold is also preheated. Once the part is clamped into the mold, pitch is injected into the part. Subsequently the pitch impregnated preform is cooled to form a solid pitch matrix. In subsequent steps oxidation stabilization is performed to thermoset the pitch by cross-linking. The stabilized pitch is then charred (carbonized). Finally, the part is subjected to further heat treatment cycles and final densification by chemical vapor deposition. Chemical vapor deposition processes are well known to those skilled in the art. The carbonized preform is placed within an evacuated heated chamber, and a carbon-containing gas, e.g., methane, is introduced into the chamber. Carbon atoms from the gas settle or infiltrate onto the filaments, filing in the free volume between the filaments, thereby increasing the density of the preform. The large amount of surface area due to high surface porosity in the preforms of this invention leads to reduced problems with surface clogging during the CVD process.

FINAL PROCESSING. Preforms configured as brake parts generally are ring-shaped. Subsequent to final shaping, an anti-oxidant layer may be applied to the exposed surface of the preform to prevent surface oxidation. Such final processing is conventional and techniques for carrying out such operations are within the expected skill of those skilled in the art to which this invention pertains.

### Reusing the Core.

Referring to FIGS. 1, 2, 2A and 3, the high heat capacity material cores 19, 7, 7, respectively, can be reused by grinding off the respective conventional carbon-carbon composite portions 15, 3, (3,1).

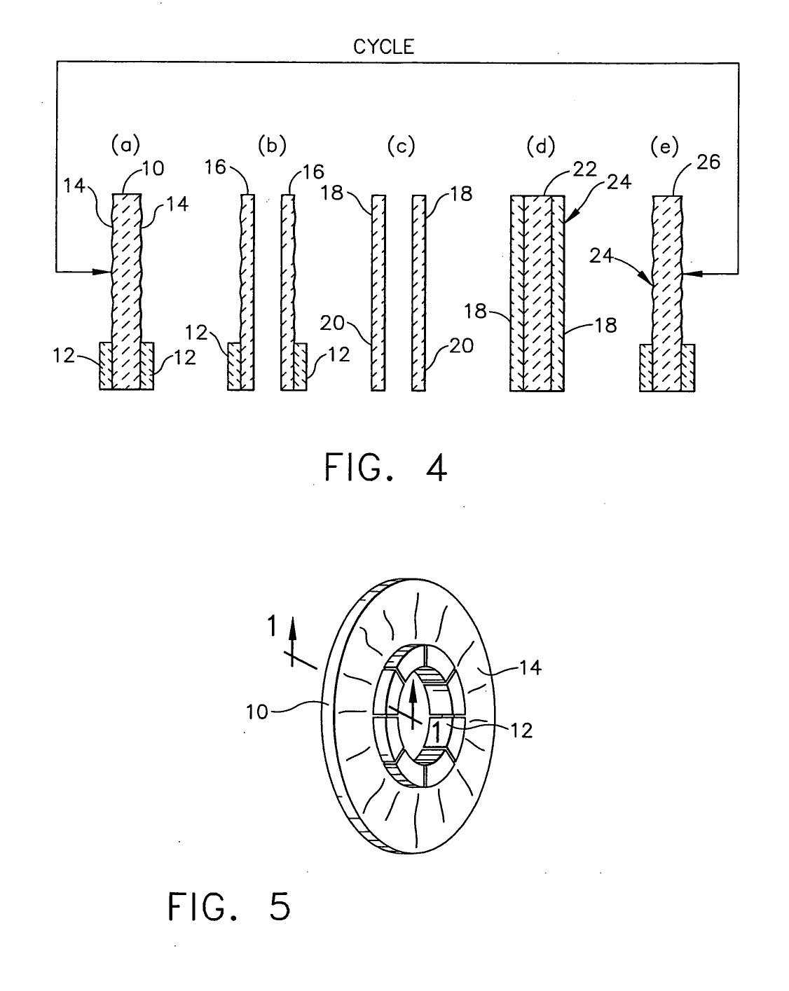

In another embodiment of the present invention, referring to (a) in FIG. 4, a worn carbon disc 10 includes axial drive regions 12 which extend axially outwardly from the worn or rough faces 14. In (b), the disc 10 is split or cut into two substantially equal disc halves 16. Disc halves 16 are then machined or sanded to a predetermined axial thickness to provide disc halves 18 illustrated in (c). Disc halves 18 includes axial drive portions 20. The disc halves 18 of predetermined axial thickness are then bonded to a high density core member 22 as illustrated in (d). High density core member 22 comprises a carbon-carbon composite friction material having a density of from 1.8 g/cc to 2.05 g/cc. The bonding may be effected by any method suitable for adhering the disc halves 18 to high density core member 22, one method being disclosed in U.S. Pat. No. 4,742,948. The high density core member 22 and disc halves 18 provide a refurbished carbon-carbon composite friction disc 24 which may be utilized within a brake of a vehicle, for example, an aircraft brake. After refurbished disc 24 has completed its service life, it will appear as illustrated in (e). An isometric view of a worn carbon disc 10 is illustrated in FIG. 5.

Alternatively, if the reusable core is, for instance, riveted or bonded into the brake disc, one would simply have to remove the rivet attachment or rupture the adhesive bond to obtain the core ready for reuse.

### EXAMPLES

The reusable core of this invention and the surrounding frictional surfaces can be made by currently known processes. Typically, nonwoven fabric, woven fabric, or random fibers are used to provide fibrous matrices. Subsequently, they are subjected to densification processes such as Chemical Vapor Deposition/Chemical Vapor Infiltration and/or pitch infiltration. In accordance with this invention, the densification procedures applied to the core are carried out in such a way as to ensure a very high density (1.8-2.05 g/cc).

### Example 1

In a typical but non-limiting process, 40 parts by weight of chopped polyacrylonitrile fibers are sprayed into an annular heat sink core mold to provide a matrix of fibers in the mold. The mold is configured with an internal ring-shaped space having an external diameter of 18 inches, an internal diameter of 9 inches, and a thickness of 1 inch. Twenty parts by weight of phenolic resin binder in powder form is simultaneously sprayed into the mold. The resulting fibrous matrix containing binder is compressed, and the binder is cured, providing a preform matrix. The preform matrix is infliltrated with pitch to form a pitch matrix. The pitch matrix is subjected to Chemical Vapor Infiltration to form a high heat capacity carbon-carbon composite core.

### Example 2

In an alternative method for forming a core for use in accordance with the present invention, a standard nonwoven fabric-based preform is densified to about 2 g/cc. The highly densified preform is then machined to a desired size and used as a core in a brake disc.

### Example 3

The reusable core preform manufactured in this way is placed in an annular brake stator disc mold configured with an internal ring-shaped space having an external diameter of 18 inches, an internal diameter of 6 inches, and a thickness of 3 inches. Sixty-five parts by weight of chopped polyacrylonitrile fibers are sprayed into the annular brake stator disc mold to provide a matrix of fibers in the mold and 35 parts by weight of phenolic resin binder in powder form is simultaneously sprayed into the mold. The resulting fibrous matrix containing binder is compressed, and the binder is cured, providing a preform matrix. The preform matrix is filled with pitch to form a pitch matrix. The pitch matrix is subjected to CVI and/or to an additional pitch infiltration step to form a carbon-carbon composite brake disc preform.

### Example 4

In another brake disc manufacturing example, polyacrylonitrile fabric arc segments are arranged in an annular form and are needled to provide a fabric matrix. The fabric matrix made in this way is placed in an annular mold and is carbonized at 900° C. The carbonized annular preform made in this way is die cut to the desired dimensions for the core of the brake disc being manufactured. It is then heat-treated to 2500° C. and subsequently subjected to Chemical Vapor Deposition at 1000° C. Next it is subjected to pitch infiltration, and again carbonized at 900° C. and then heat-treated to 2500° C. Yet again, it is subjected to pitch infiltration, and yet again carbonized at 900° C. The density of the carbon-carbon composite core made in this way is about 1.9 g/cc. Repeating the heat treatment followed by another pitch infiltration and carbonization raises the density to about 2 g/cc. At this point the dense carbon-carbon composite may be machined to fit into the surface pocket of the friction material of the brake disc and riveted in place within the brake disc. In this manner, a carbon-carbon composite brake disc having a reusable core of dense carbon-carbon composite material is produced.

1. A method of manufacturing a carbon-carbon composite brake disc with a reusable core, said method comprising the steps of:
forming a dense carbon-carbon composite core with high heat capacity from materials selected from the group consisting of
(i.) a fibrous matrix and
(ii.) a fibrous matrix and a resin binder
by densifying said fibrous matrix with Chemical Vapor Deposition/Chemical Vapor Infiltration and/or pitch infiltration, said dense core having a density of from 1.8 g/cc to 2.05 g/cc;
recovering said dense carbon-carbon composite core from a worn brake disc;
positioning the recovered dense core in a location within a carbon-carbon composite brake disc; and
fixing said dense carbon-carbon composite core in place in its location within said carbon-carbon composite brake disc.

2. The method of claim 1, wherein the fixing step comprises molding, riveting, or adhering said core into said carbon-carbon composite brake disc.

3.-17. (canceled)

18. The method of claim 1, wherein said dense carbon-carbon composite core comprises 40-75 weight-% carbon-containing fibers and 25-60 weight-% resin binder and said carbon-carbon composite brake disc comprises a friction surface containing 15-75 weight-% carbon-containing fibers and 25-85 weight-% resin binder.

19.-24. (canceled)

25. The method of claim 1, wherein said dense carbon-carbon composite core is formed from (ii) chopped polyacrylonitrile fibers and phenolic resin binder.

26. The method of claim 1, wherein said dense carbon-carbon composite core is formed from (i) needled polyacrylonitrile fabric.
